(19) United States
(12) Patent Application Publication
(10) Pub. No.: US 2003/0221020 A1
(43) Pub. Date: Nov. 27, 2003

(54) Unified group messaging

(76) Inventor: Petr Hejl, White Rock (CA)

Correspondence Address: Clifford W. Vermette, Vermette & Co., Box 40, Granville Square, 200 Granville Street, Suite 230, Vancouver, BC, V6C 1S4, CA

(21) Appl. No.: 10/444,996

(22) Filed: May 27, 2003

(30) Foreign Application Priority Data
May 24, 2002 (CA) 2,387,454

(51) Int. Cl. G06F 9/46

(52) U.S. Cl. 709/313

(57) ABSTRACT

At present, the group message is defined to be set of to be sent or sent messages. This model has several disadvantages, as it is not possible to receive, store and evaluate the messages.

In the invention, not only to be sent or sent messages but also received messages can form a group message. And moreover, a group message can include not only simple messages, but also group messages.

The most important suggestion is, that one of the parameters, defining the group message structure, is the type of group message. There are mentioned 16 types of group messages, e.g. simple message, answer message, contest, betting, voting, chat or auction; also other types can be created based on the invention.

The said method enables to realize one general model of group message, to define the group message in unified way using common and special data and to run the group messaging using messaging engines.

### FIELD

The present invention relates to an automated method of sending and receiving group messages which can cover many different kinds of messaging structures.

### BACKGROUND

According to an old definition, a group message is a set of simple messages to send or which have been sent (see FIG. 1). I.e. a group message can only be made up of simple messages, to be sent or which have been send. This definition has several disadvantages, does not enable for a group message to include other group messages and omits the receiving. Based on this definition, existing systems for group messaging have no provision for receiving, storing and processing messages. In particular there is no provision to allow for questioning of the recipients of the group message.

It would be useful if a group message could contain simple as well as group messages. So the subsets within the group messages may be constructed, corresponding to particular categories or subjects. It would be further desirable if a group message included not only messages to send or which have been sent, but also received messages. With such a group message, one could not only send messages, but also receive, store and process them. Also questionnaires could be implemented by which one or many questions are sent to the recipients and replies from them are received, stored and processed.

From the reasons stated above a new definition of message and group message is suggested here (see FIG. 2). A message can be a group message or a simple message. A group message is a set of messages, which are sent to a set of recipients or which are received from a set of senders. A simple message is one message, sent to one recipient or received from one sender.

Following FIG. 3, the user of group messaging can define groups, which consist of members. The members of the groups are recipients and senders of messages. These members can be social structures such as organisations or companies; they can be also persons, computers . . .

General messaging scheme (see FIG. 4) consists from user, groups, group messages and messages. The user can define groups, the user and group members can send and/or receive group messages, while each group message consists of (simple or group) messages.

There are three kinds of messages, namely, those that are sent to recipients, those that are initiated and received from senders, and finally replies (received from recipients as reactions to messages, sent to them).

### SUMMARY OF THE INVENTION

According to the invention there is provided a system of messaging, which includes a www.page generator operative to generate www.pages in response to an address received from an external computer; a user communicator coupled to a computer operative to receive group message definitions from the computer and to convert them to a file storage area format and a file storage area operative to receive group message parameters from the user communicator and to store them. A group message sender and receiver is coupled to the file storage area and couplable to external communication devices. The group message sender is operative to extract messages from the file storage area, convert them to communication format and to send them to the external communication devices. It also receives messages from the communication devices, converts them to file storage format and stores them in the file storage area.

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a schematic diagram of a prior art group message system;

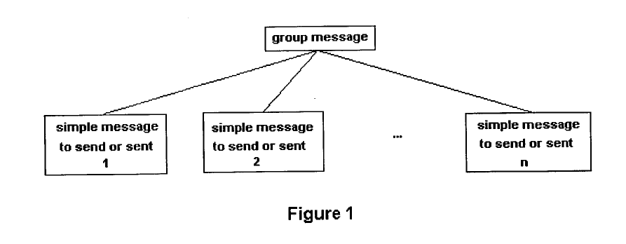

FIG. 2 is a schematic diagram of a group message system according to a preferred embodiment of the present invention;

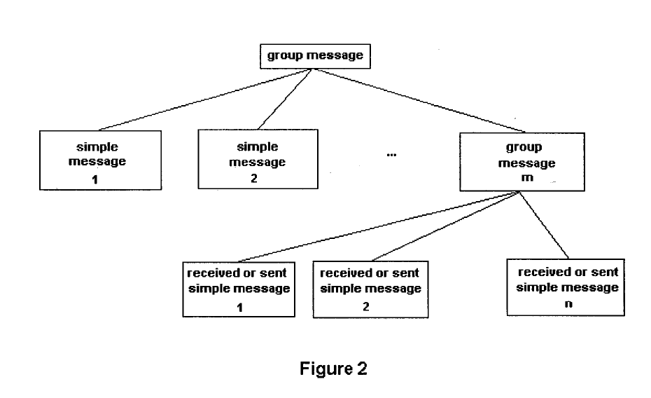

FIG. 3 is a schematic diagram of a group system in which a user communicates with multiple groups and, each group is made up of several members; and

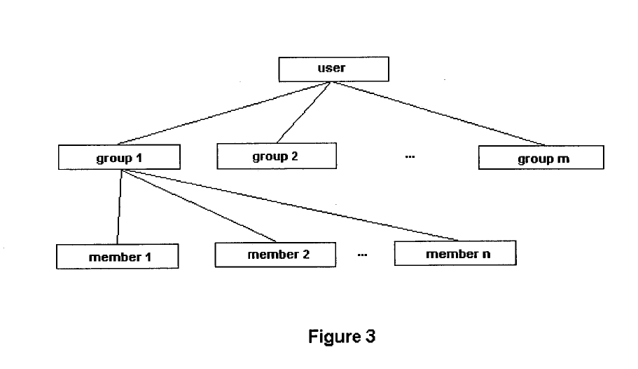

FIG. 4 is a schematic diagram of the flow of messaging according to a preferred embodiment of the present invention.

FIG. 5 is a schematic diagram of the Unified Group Messaging communication system, used to send and receive messages.

### DETAILED DESCRIPTION OF THE PRESENT INVENTION

In the following the term user refers groups and the members of these groups. In the groups, there are recipients and senders each of which may be may be organisations, companies, persons, computers, etc.

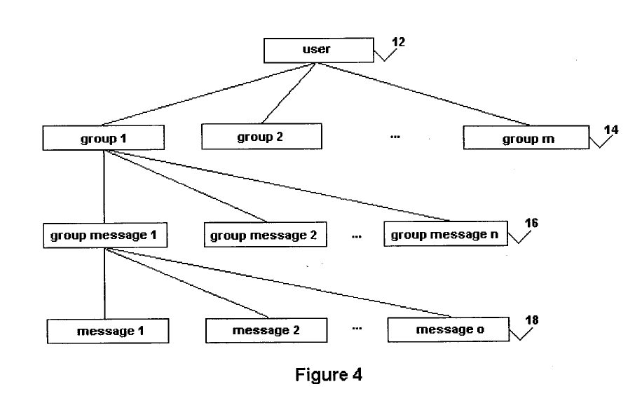

Referring to FIG. 4, the user 12 defines the groups 14 and may send group messages 16 to these groups 14. The sent messages 18 will be delivered to the members of the groups. Vice versa the members of the groups may send messages to the user, either independently, or as reaction to the messages received. The messages, received from the members of the groups, can be stored on the computer or server, evaluated, and sent directly to the user (e.g. to his/her mobile phone) . . .

The above described system allows one to insert a number of group message types under the category of “group message”. For example group message types could include the following:

(1) simple message (just sent)

(2) confirmation message (when confirmation concerning message delivery is required)

(3) answer message (some message is sent and answer is received)

(4) evaluation message (message is received and evaluated)

(5) contest (competition)

(6) betting (pool)

(7) voting (poll)

(8) opinion research

(9) opinion statements (opinions concerning some subject are received)

(10) master messaging (group master sends and receives messages)

(11) distribution (messages are distributed to the users, e.g. news, information, advertisements)

(12) conference (users send messages, the messages are distributed by the administrator to the members)

(13) chat (users send messages and these messages are distributed to the users)

(14) data collection (data are collected from sources, e.g. measuring instruments)

(15) action confirmation (messages are send and received in defined times—calendar, reminder, alerting . . . )

(16) auction

Input parameters define a group message. These parameters can be divided into two sets: common data (for all group message types) and special data (concerning some group message types)

Group Name

A group name is defined by the user and corresponds to the entities to which messages are sent and from which the messages are received, e.g. family, friends, business.

Group Message Name

Unique name or unique name within the group. E.g. Dinner, Soccer, Meeting. . .

Group Message Type

Simple message, confirmation message, answer message, evaluation message, contest, betting, voting, opinion research, opinion statements, master messaging, distribution, conference, chat, data collection, action confirmation, auction. . .

Abbreviation

Abbreviation is used when sending messages from persons to a communication system, which receives, stores and evaluates the messages. The person sends message (e.g. email, SMS message), which starts with group message abbreviation, followed by the text of group message. E.g. BET Hockey Canada:USA 2:1. This means betting for hockey between Canada and USA to be 2:1.

Begin Date

This is the date, when the original message is send to the group members and when received messages (replies) start to be accepted.

Begin Time

This is the time, when the original message is send to the group members and when received messages (replies) start to be accepted.

End Date

This is the date, when received messages (replies) stop being accepted.

End Time

This is the time, when received messages (replies) stop being accepted.

Special Data

Here always group message types are written, followed by data names and descriptions.

### Distribution, Conference, Chat

Category

Messages within the group message can be divided into categories. This is used for example in chats, when one discusses one special category (animals, hockey . . . ).

Data Collection, Action Confirmation, Auction:

Subject

Defines the thing, which is the subject of the group message. For example in auctions the subject is the name of the auctioned item.

Evaluation Message, Contest, Betting, Voting, Opinion Research:

How to Process Received Multiple Messages

Sometimes, from the same group member two or more messages are received. There are options as to how to process these received multiple messages which are set forth below:

ignore all received multiple messages from one member

accept first received message from one member

accept last received message from one member

accept all received messages from one member

Evaluation Message, Contest, Voting, Opinion Research:

Keywords to Classify the Received Messages

Keywords can be defined, which serve to classify the received messages into subsets. For each subset, many (equivalent) keywords may be prescribed, divided by commas. e.g. for the question “How do you like hockey” following four keyword subsets can be defined:

no, not, dislike, hate

maybe, perhaps, possible

ya, ye, yes, ok, sure

enjoy, much, love, yeah

Contest:

Correct Answer Keywords

Many different keywords may be defined as correct answers, These keywords are separated by commas.

For example, for the question “How many planets has our planetary system” correct answers are: 9, nine. When the received message contains at least one of the correct answer keywords (as a whole word), such received message is declared to be correct.

Contest:

Number of Winners

Number of winners is defined (1, 2, 3 . . . ).

Contest:

From which Set the Winners are Chosen

This item can have the following values:

no winners

winners are chosen from correct messages (answers)

winners are chosen from all acceptable (possible) messages (answers), which contain at least one keyword

winners are chosen from all answers

Contest:

How Winners are Chosen

This item can have the following values:

no winners

first in date and time received message(s) (answers) will win

there are fixed winning positions (e.g. 1, 3, 7)

winners are chosen by random

all people who are in the chosen set (see above) win

Contest:

Fixed Winning Positions

Fixed winning position may be defined, separated by commas. E.g. 1, 3, 7 means, that the first, third and seventh received message will win.

Betting:

Winning Answer Keywords Keywords are defined for winning answers and separated by commas. When the received message contains at least one of the winning answer keywords, it is classified into the set of received messages, from which the winners are chosen.

Action Confirmation:

Where to Receive Confirmation SMS Messages

This item can have the following values:

message text will be sent only, no replies

directly (via SMS center) to user's actual phone

indirectly (via group messaging communication system) to user's actual phone

to virtual mobile phone (SMS box)

to actual and virtual mobile phone (SMS box)

Action Confirmation:

Which Days

At which days the action confirmation is to be performed: workdays, holidays, all . . .

Action Confirmation:

Begin Time

At which time of the day action confirmation begins.

Action Confirmation:

End Time

At which time of the day action confirmation end.

Action Confirmation:

Interval

Number of minutes between two confirmations.

Action Confirmation:

Before Range

Number of minutes before each confirmation time begin when confirmation messages are accepted.

Action Confirmation:

After Range

Number of minutes after each confirmation time end when confirmation messages are accepted.

Action Confirmation:

How to Process Nonconfirmation Warnings

In case action or presence was not confirmed, there are the following options:

(1) No. Action confirmations are not saved and sent, Action or presence nonconfirmation warnings will not be sent;

(2) Master. Action or presence nonconfirmation warnings will be sent to the master's (user's) mobile phone

1. Confirmer. Action or presence nonconfirmation warnings will be sent to the person, who should perform the confirmation

(4) Box: action confirmations will be saved to the communication message box

(5) All: action confirmations will be saved to the communication message box and action or presence nonconfirmation warnings will be sent to the master and to the confirmer

Action Confirmation:

Master Mobile Phone Number

Where the nonconfirmation warnings will be sent.

Auction:

Registration Begin Date

Date, when the registration of the auctioneers begins.

Auction:

Registration Begin Time

Time, when the registration of the auctioneers begins.

Registration End Date

Date, when the registration of the auctioneers ends.

Auction:

Registration End Time

Time, when the registration of the auctioneers ends.

Auction:

Begin Price

Starting price of the auctioned object.

Auction:

Currency

Currency, in which the auction price is stated.

Auction:

Waiting Interval

How long will auction wait for new price suggestions (messages), after preceeding price change (in minutes).

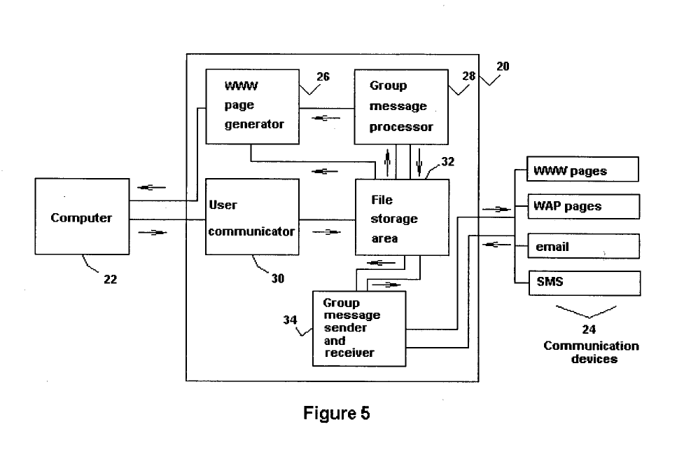

Referring to FIG. 5 the software that defines the software system is stored on a server 20, although it could also be stored on a computer 22 if the computer had some means of communicating with communication devices 24. The system includes a www.page generator 26 coupled to the computer 22 and accepts the definitions of the group messages and the requests for actions with group messages (storing, processing, evaluating, sending, etc.). A group message sender and receiver 34 sends messages to communication devices 24 and receives messages from the communication devices 24. A group message processor 28 processes the messages by sorting, evaluating, etc. and then prepares the results for the www.page generator 26 to be sent to the computer 22. A file storage area 32 is coupled to all of the modules of the system and stores messages and stores the group message definitions. The communication devices 24 include www.pages, email, SMS, etc.

In operation, a user through the computer 22 requests processing of received group messages and this request is accepted by the user communicator 30 and saved to the file storage area 32. In response to this request the group message processor 28 is activated and processes the messages for the www.page generator 26. The www.page generator 26 sends the result to the computer 22.

By this system, increased power in group messaging is achieved. By the present system, the term “group message” covers not only sent, but also received, stored and processed messages. Many different messaging structures can be realised by this group messaging system.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

I claim:

1. A system of messaging, comprising:
(a) a www.page generator operative to generate www.pages in response to an address received from an external computer;
(b) a user communicator coupled to a computer operative to receive group message definitions from the computer and to convert them to a file storage area format;
(c) a file storage area operative to receive group message parameters from the user communicator and to store them;
(d) a group message sender and receiver coupled to the file storage area and couplable to external communication devices operative to extract messages from the file storage area, convert them to communication format and to send them to the external communication devices and to receive messages from the communication devices, convert them to file storage format and to store them in the file storage area.
